(19) United States
(12) Patent Application Publication
(10) Pub. No.: US 2021/0133350 A1
(43) Pub. Date: May 6, 2021

(54) Systems and Methods for Automated Securing of Sensitive Personal Data in Data Pipelines

(71) Applicant: TrustLogix, Inc., Sunnyvale, CA (US)

(72) Inventors: Ganesh Kirti, San Jose, CA (US); Kamalendu Biswas, San Ramon, CA (US)

(73) Assignee: TrustLogix, Inc., Sunnyvale, CA (US)

(21) Appl. No.: 17/092,179

(22) Filed: Nov. 6, 2020

Related U.S. Application Data
(60) Provisional application No. 62/931,697, filed on Nov. 6, 2019.

(51) Int. Cl. G06F 21/62; G06F 16/25

(52) U.S. Cl. CPC G06F 21/6245; G06F 16/254

(57) ABSTRACT

Systems and methods for restricting access and visibility to sensitive personal data during ingestion and storing within a data repository are disclosed. In one embodiment, a process for protecting personal data includes establishing a connection from a personal data protection system to a data source, retrieving raw data comprising personal data from the data source, classifying pieces of information within the personal data into one or more levels of sensitivity, storing the raw data in a data repository, enforcing one or more privacy policies on the personal data by obfuscating pieces of information that are at one of the levels of sensitivity using the personal data protection system, and enforcing one or more access control policies for one or more user accounts having access to the data repository by limiting visibility of the personal data to a subset of the personal data, based upon attributes of the user account.

### RELATED APPLICATIONS

The present application claims priority to U.S. Provisional Patent Application Ser. No. 62/931,697, filed Nov. 6, 2019, the disclosure of which is incorporated by reference in its entirety.

### BACKGROUND OF THE INVENTION

The explosion of data, and in particular sensitive personal data, generated and used by businesses is tempered in part by a need to track and secure the data. Personal data can include personally identifiable information (PII). One definition of PII provided by the U.S. General Services Administration is “information that can be used to distinguish or trace an individual's identity, either alone or when combined with other personal or identifying information that is linked or linkable to a specific individual. Sensitive data as discussed herein may also include information considered confidential.

Data, typically including many different types of personal data, flows across many entities on networks used by consumers and enterprises, such as mobile devices, servers, and cloud services. Due to the increasing value and centralization of personal data, external actors constantly attempt to hack into datastores of personal data and malicious organization insiders may take advantage of unauthorized use of personal data. Banks, credit card providers, retailers and even social networks are among many companies that have been sued and held liable for data breaches no matter the security measures that were in place.

The growing concern over data breaches birthed a number of data privacy and security standards. For example, regulations such as the US Health Insurance Portability and Accountability Act (HIPAA), California Consumer Privacy Act (CCPA) in California, General Data Protection Regulation (GDPR) in the European Union, Lei Geral de Proteção de Dados (LGPD) in Brazil place requirements on business which collect and process personal data. This can include rules over the type of data that may be collected, the level of control that a consumer has over that data, and the technical measures that must be taken to secure the data. There are also organic efforts by consumer advocacy organizations to advance public interest in requiring organizations to be responsive to customer queries and audits of personal data collections and usage.

Companies may often store data in their own cloud or the cloud of a service provider. The “cloud” has come to represent a conglomerate of remotely hosted computing solutions and the term “cloud computing” can refer to various aspects of distributed computing over a network. Various service models include infrastructure as a service (IaaS), platform as a service (PaaS), software as a service (SaaS), and network as a service (NaaS). A “cloud” can also refer to the data store and/or client application of a single service provider. Cloud applications connect a user's device to remote services that provide an additional functionality or capability beyond what is available solely on the device itself.

Typically, companies perform manual processes to safeguard the personal data on their systems, whether hosted on their own network or in a cloud. Security policies govern how personnel roles may access personal data and technical barriers (e.g., encryption) to the data. The security policies are often implemented manually by system administrators modifying settings on individual databases and/or interface systems. Changes to policies or requests to policies often result in the necessity of manual approvals and system configuration.

### BRIEF DESCRIPTION OF THE DRAWINGS

FIG. 1 is a system overview illustrating devices and cloud application service providers that can interact with a personal data protection system in accordance with several embodiments of the invention.

FIG. 2 is a flow chart illustrating a process for securing personal data while retrieving it from data sources in accordance with several embodiments of the invention.

FIGS. 3-8 are graphical user interface screens showing various features and capabilities of a personal data protection system in accordance with several embodiments of the invention.

FIGS. 9-12 conceptually illustrate a user's access to data and the effects of access control policies and privacy policies in accordance with several embodiments of the invention.

FIG. 13 illustrates a process for securing personal data in accordance with embodiments of the invention.

FIG. 14 illustrates a system diagram for implementing a personal data protection system in accordance with some embodiment of the invention.

### DETAILED DISCLOSURE OF THE INVENTION

Turning now to the drawings, systems and methods for autonomously enacting data security policies in accordance with embodiments of the invention are disclosed. A paradigm utilized in modern data processing is ETL (Extract, Transform, Load)—referring to stages involved in moving raw data from sources, which can be referred to as data lakes, to data warehouse(s) and/or file(s) where applications can be run against the data. Some examples of services that can provide data lakes and other data processing tools are Amazon Web Services, Google Cloud Platform, and Microsoft Azure, as well as others. Examples of types of databases that may be used as data warehouses are Relational Database Management System (RDBMS), NoSQL, and other database architectures suitable for large and/or distributed datasets. While specific terms may be used below, one skilled in the art will recognize that concepts would be applicable to other cloud services, architectures, and database formats as appropriate to a particular application. Moreover, multiple cloud services may be utilized in a system simultaneously to service users using different services.

Existing systems typically are not equipped to secure personal data as may be required during ETL. Many challenges for a data management entity to effectively and efficiently keep sensitive data protected before release into target environments include: disparate data pipeline tools for working with data through ETL stages, different privacy regulations that must be adhered to, and third-party intrusion threats.

In many embodiments of the invention, a single management system and user interface can provide an automated data solution with enforcement of security and privacy embedded in the data layer. Features of the management system can track which data is sensitive and secure this data from the early discovery stages through transformation and loading into databases. As discussed further above, enterprises collecting data are often hindered by a complex data ecosystem in handling multiple data pipeline tools and across multiple cloud services to process and share data. Embodiments of the invention can provide a simple and efficient solution by providing a single central management system for governance of protecting sensitive personal data through all the disparate data pipeline systems. The central management system can identify and secure sensitive personal data in the various data pipelines, while presenting a uniform interface to a user and providing services in an automated hands-off manner. An objective in many embodiments of the invention is to maintain personal data that is stored “at rest” in a protected form (e.g., encrypted) so as to stay in compliance with government regulations concerning data privacy.

In some embodiments, the system can be implemented as SaaS (software as a service). In other embodiments, the system can be embedded at a single tenant. The system may be implemented using infrastructure tools available to automated web services. Suitable tools can include, but are not limited to, AWS Glue and Lambda for Amazon Web Services, Kafka plugin for Kafka, and Jenkins for Cl/CD (continuous integration/continuous deployment) data ops.

In many embodiments of the invention, a system for data security includes applications executing on one or more hardware platforms, user interface components displayed by one or more hardware platforms, and data warehouses stored on one or more hardware platforms. Such hardware platforms may include at least a processor and non-volatile memory containing instructions directing the processor to perform processes such as those discussed further below.

### System Architecture for Personal Data Protection Systems

A system for securing personal data in accordance with embodiments of the invention can include multiple components that may be located on a single hardware platform or on multiple hardware platforms that are in communication with each other. Components can include software applications and/or modules that configure a server or other computing device to perform processes for personal data protection in accordance with embodiments of the invention as will be discussed further below.

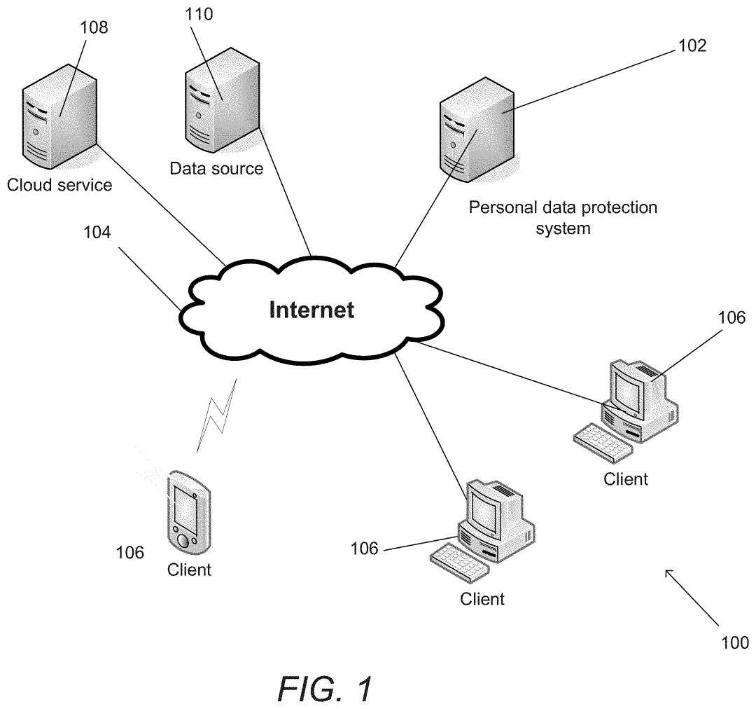

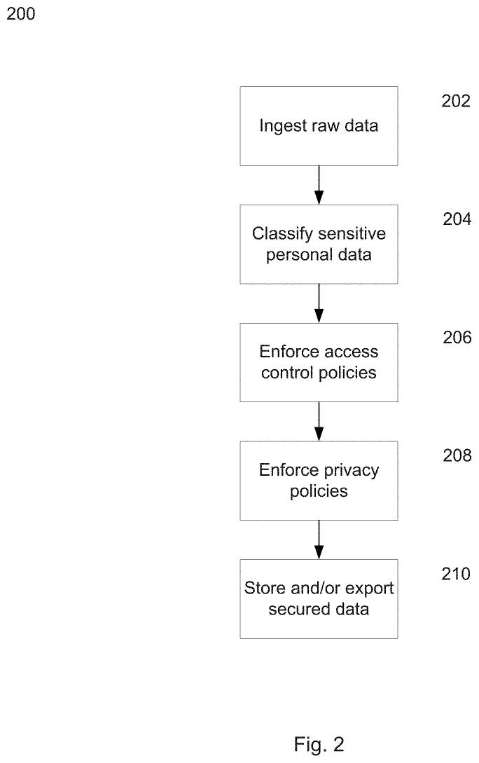

A system including a personal data protection system 102, client devices 106 that can be used to access the personal data protection system 102, one or more cloud services 108, and one or more data sources 110 in accordance with embodiments of the invention is illustrated in FIG. 1. The system 100 can include a number of different types of client devices 106 that each has the capability to communicate over a network. The client devices 106 may communicate with the personal data protection system 102 and present a user interface (e.g., web or application interface) for interacting with the service. The personal data protection system 102 may communicate with cloud application services 108 and/or data sources 110 to retrieve and process personal data as will be discussed further below. In many embodiments of the invention, at least some of the personal data is obfuscated (e.g., by encryption) or depersonalized. In several embodiments of the invention, the processed personal data is stored on the personal data protection system or in another data repository. For example, the processed personal data may be stored in one or more cloud service 108. In some embodiments, all of the personal data is stored in the same repository. In other embodiments, portions of the personal data are stored on one repository while other portions are stored on other repositories. One skilled in the art will recognize that any of a variety of configurations may be utilized in accordance with embodiments of the invention to retrieve, process, and store personal data using a personal data protection system.

### User Roles

Users associated with an organization may have user accounts that grant some kind of access to data in a database or other type of datastore (e.g., within a cloud). Levels of permissions and/or access may be granted to an individual user account based on a user role assigned to the user account. User roles can be in the form of template profiles that specify rules governing what data may be accessed and can be assigned to specific user accounts, for example, based upon their intended usage of the system (e.g., organizational/employment responsibilities).

Two categories of user roles can include data consumer role and administrator role. Data consumer roles can include for example, but are not limited to, data scientist, business intelligence analyst, and/or business user. A user acting as a data scientist may have the responsibility to build models such as machine learning models for fraud detection, customer engagement, or other similar operations. A data scientist role may thus have access to customer data and third-party data. A user acting as a business analyst may have the responsibility of identifying customer usage patterns. A business intelligence analyst may thus have access to customer data sources. A user acting as a business user may have the responsibility for executing trades for customers. A business user role may thus have access to trading data based on entitlements.

Data administrator roles can include for example, but are not limited to, data engineer and information security/data protection officer. A user acting as a data engineer may have the responsibility to build datasets for various teams within an organization. A data engineer user role may thus have full access to data pipelines or other sources of raw data.

Although specific user roles and associated permissions and access are discussed above, one skilled in the art will recognize that any of a variety of user roles and associated permissions and access may be utilized in accordance with embodiments of the invention.

### Processes for Securing Personal Data in Data Pipelines

A process for protecting sensitive personal data in data streaming architectures in accordance with embodiments of the invention is illustrated in FIG. 1. The process 100 includes retrieving and analyzing (102) raw data from at least one data source. This can be embedded in a data processing pipeline, for example, in-line with ETL processing. In several embodiments, the process may also include collecting the raw data using one or more data discovery tool(s) and/or performing some processing on the raw data to prepare it for entry into a data repository or a cloned data repository. For example, data may be normalized or transformed to another format (e.g., a common format) so that data from different sources may be combined. Data can be prepared from types of data pipelines such as, but not limited to, data lakes, Kafka, and/or Cl/CD data ops jobs. Other data sources can include, but are not limited to, Amazon Redshift, Amazon EMR, Databricks, AWS Glue, Snowflake, PostgreSQL, and Microsoft SQL Server. Further embodiments of the invention include receiving login credentials or otherwise authorizing a personal data protection system to access data from a particular data source using a particular account.

The process identifies and/or classifies (104) pieces of data that contain sensitive personal information. The classification of personal data can include classifying into different levels and/or categories to comply with one or more data privacy or data security standards. The process can identify fields or parts of data that are sensitive and/or include personal or personally identifiable data. Some embodiments utilize one or more data catalog services, such AWS Glue or Collibra, to create a catalog of personal attributes (e.g. metadata). The data catalog can be used to generate or refine data privacy policies such as those discussed below and/or to improve detection of sensitive personal information in newly received raw data. In further embodiments, machine learning is utilized to refine the classification of personal data over time. In some embodiments, the classification is triggered by receipt of new raw data at the data source. In other embodiments, it can be a manual trigger to analyze existing data.

The process enforces (106) at least one access control policy and/or at least one data privacy (108) policy on the raw data. The access control policies can specify rules which user roles and/or specific user accounts are permitted to access certain categories of sensitive personal data once it is entered into the data repository. The data privacy policies can specify rules for how certain categories of sensitive personal data are securely stored in the data repository. If no data privacy policy is stored or a new policy is desired, it can be created. Data privacy policies can include compliance policy templates that aim for compliance with privacy standards (such as, but not limited to, HIPAA, CCPA, GDPR, etc.), custom templates created by a user, and/or data obfuscation templates (to apply techniques such as, but not limited to, encryption, tokenization, etc. to sensitive data).

Enforcing an access control policy can include setting the permissions of one or more user accounts in the system. The permissions may be restricted in ways such as granting access only to certain types or categories of personal data or to personal data that is obfuscated or depersonalized. A set of permissions may be saved as a template that can be referred to as a user role that represents a type of position that may be suitable to other users in that position. In some embodiments of the invention, the creation or defining of access control policies can be asynchronous or separate from the data ingestion (e.g., ETL process) from a data source. Access control policies are discussed in greater detail further below.

Enforcing a data privacy policy can include obfuscating personal data in some way, such as encryption (e.g., multi-party compute) and/or depersonalization (e.g., masking, pseudo-anonymization, tokenization, differential privacy, MPC, etc.). Several embodiments of the invention utilize event-driven computing services, such as AWS Lambda, to impose the policies on the data pipeline. Services such as AWS Lambda may be serverless in that code is not necessarily written for execution on specific servers. Other embodiments may utilize other mechanisms to implement policies that are less abstract and are bound to specific machines. In many embodiments of the invention, defining the parameters of a privacy policy can be asynchronous or separate from data ingestion (e.g., ETL), while enforcement of the privacy policy is performed during data ingestion from a data source. Data privacy policies are discussed in greater detail further below.

The resulting dataset (108), protected by restricted access and obfuscation, can be referred to as secured data. Secured data can be safely viewed by consumers, or used for other purposes such as analytics, machine learning models, and/or third parties with reduced privacy concerns. In some embodiments of the invention, the secured dataset is stored in a separate data repository. In other embodiments it can be stored in the original data repository, either replacing and deleting the original data or alongside the original data. The original data and the secured data may have different access permissions according to the data privacy policies. In some embodiments of the invention, the system may maintain an intermediate copy of the dataset that is not fully processed through obfuscation as stage data that can be used for other purposes. Although a specific process is discussed above with respect to FIG. 1, one skilled in the art will recognize that any of a variety of processes may be utilized in accordance with the invention. The remaining figures illustrate various implementation configurations in different environments according to additional embodiments.

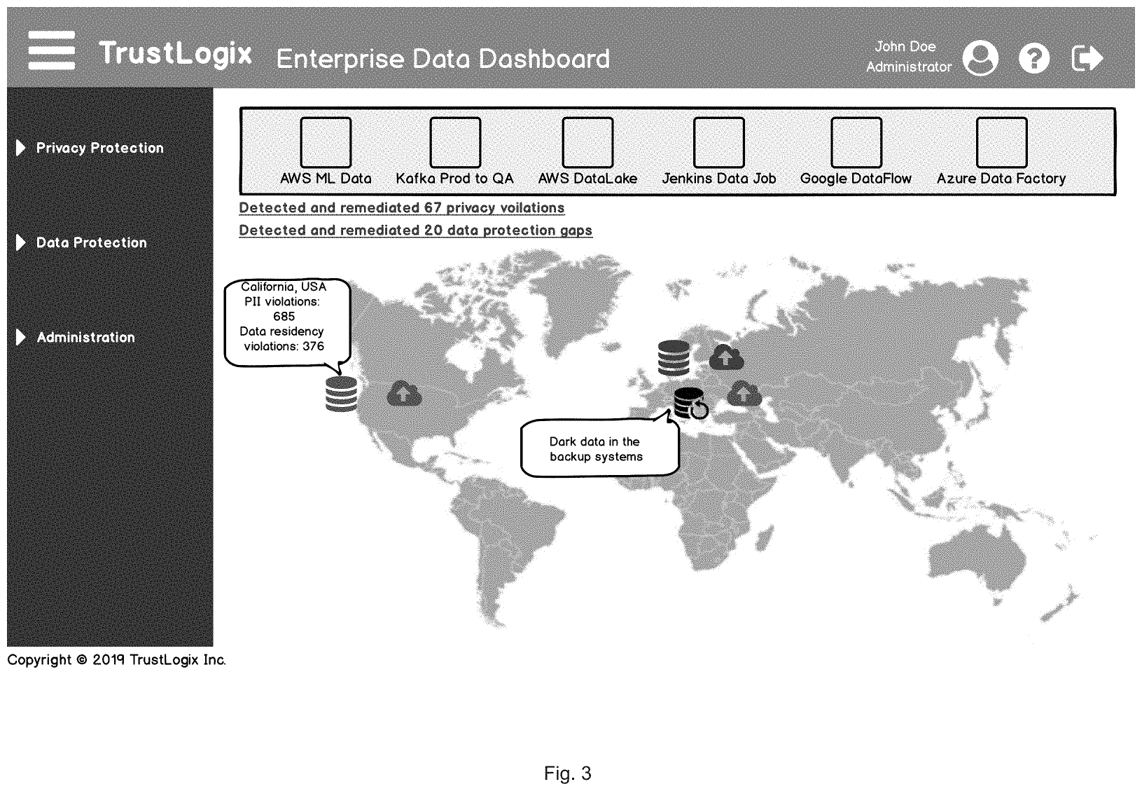

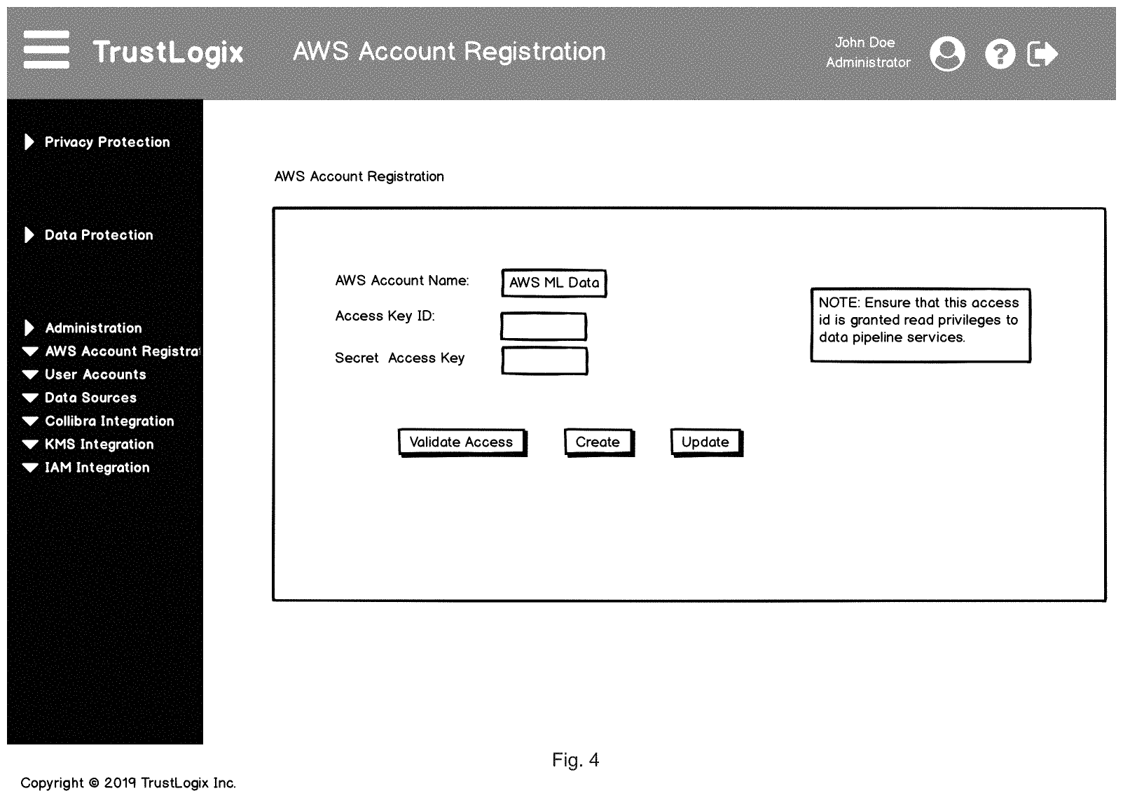

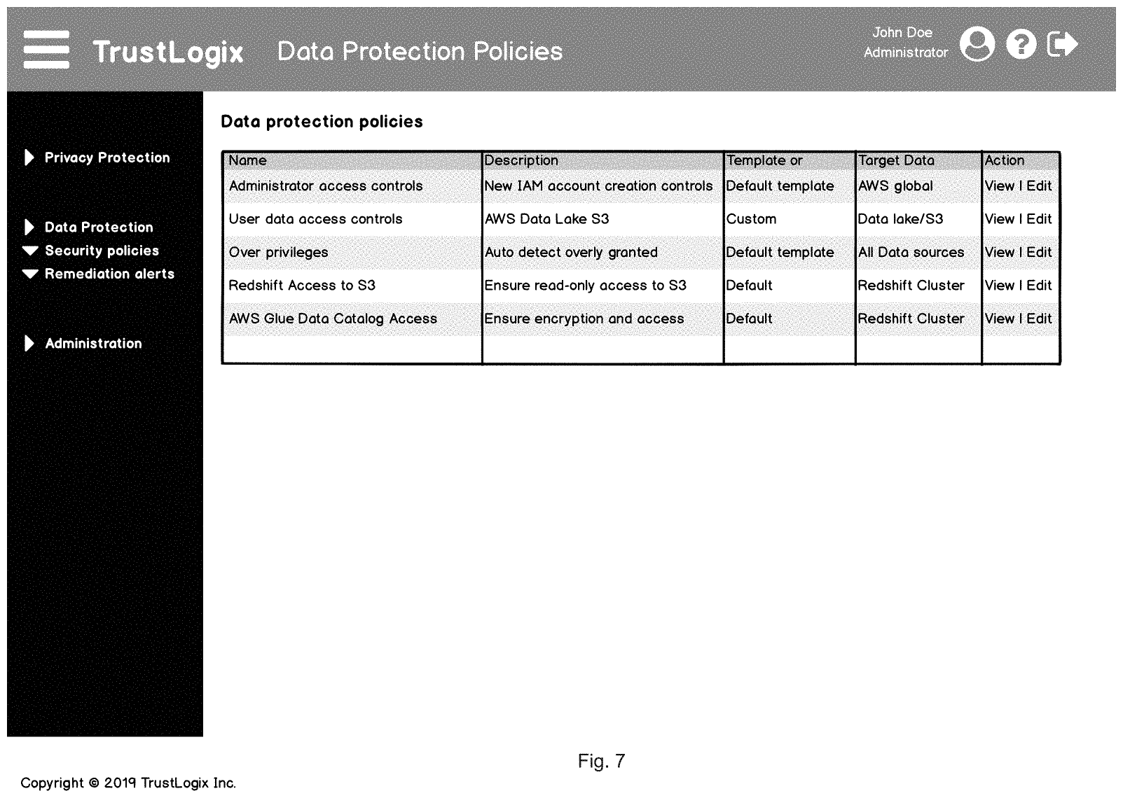

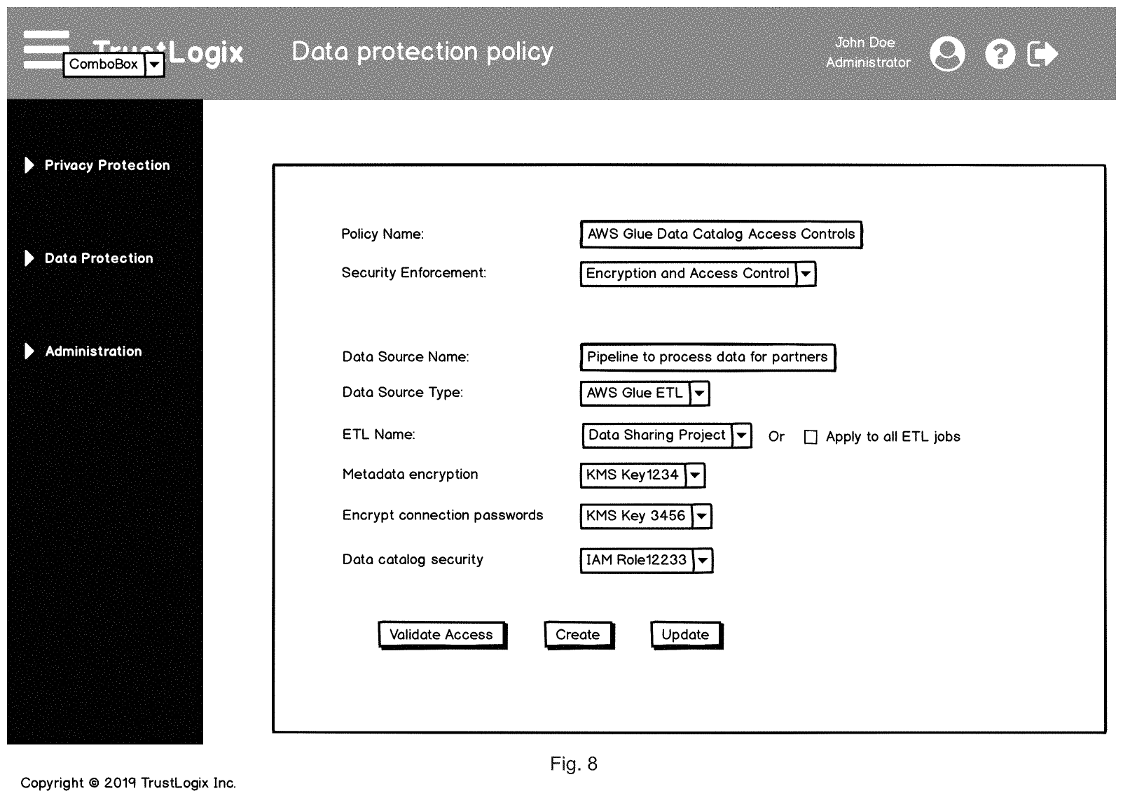

In several embodiments, the process involves management by a monitoring and observability service that can provide data activity notification events, such as AWS Cloudwatch. The monitoring and observability service can coordinate event handling and trigger features such as those that transform sensitive data into a more secure form. It can also coordinate events such as those discussed above with respect to detecting raw data to be processed and forming or updating a catalog of data attributes. A management console as a user interface can provide visibility into the data flows, policies, and other aspects of the system as well as configurability by a user. Additional embodiments of the invention include reporting services to provide reports on data classification, data compliance, data authorization, data privacy, and/or audit. FIGS. 3-8 illustrate example screens of a management console in accordance with some embodiments of the invention.

In still further embodiments of the invention, the system can generate trust scores for data pipelines, where the trust score indicates a level of security of the data pipeline. The trust score can be assigned based on factors including, but not limited to, sensitiveness of the data flowing through the data pipeline and activity by devices or users. A trust score can provide information relevant to taking actionable steps, such as reconfiguring security policies or permissions.

### Establishing User Account Access Controls

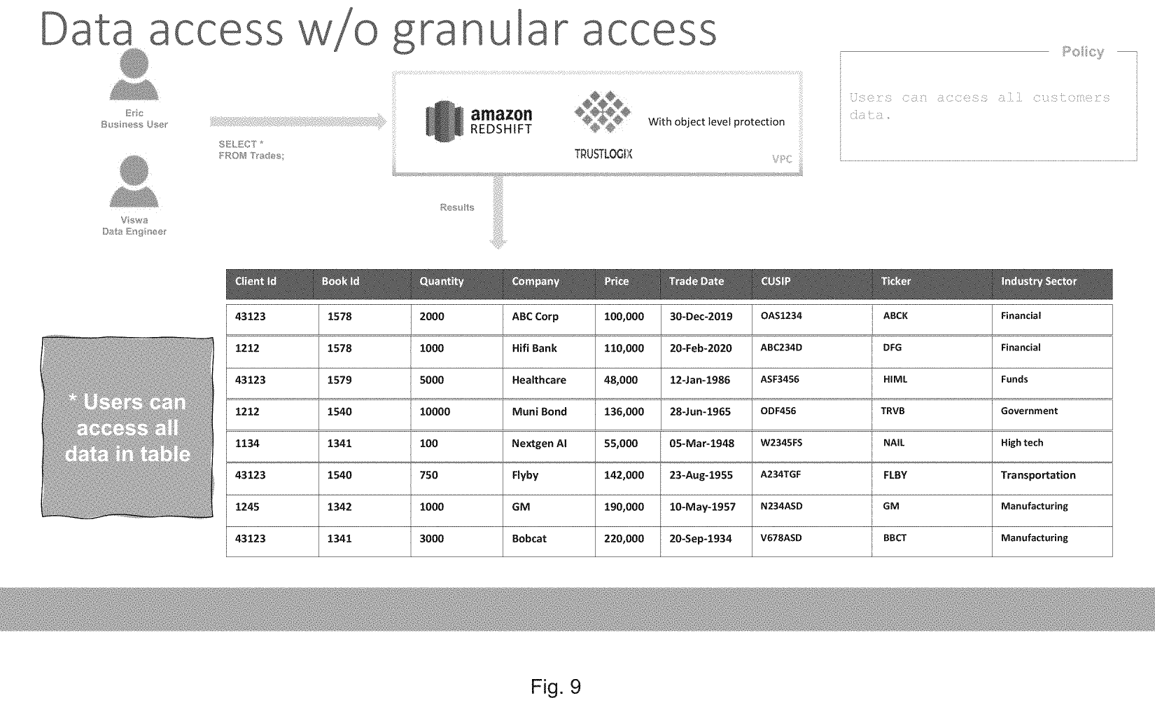

Typically, in data systems that are set up without any controls a user may access all data in a dataset without restrictions. This is often not be desirable as discussed above because of privacy and regulatory issues. An example of an unrestricted user account and some data it may access in a table are illustrated in FIG. 9. In the illustrated example all data in the table may be accessed by the business user account.

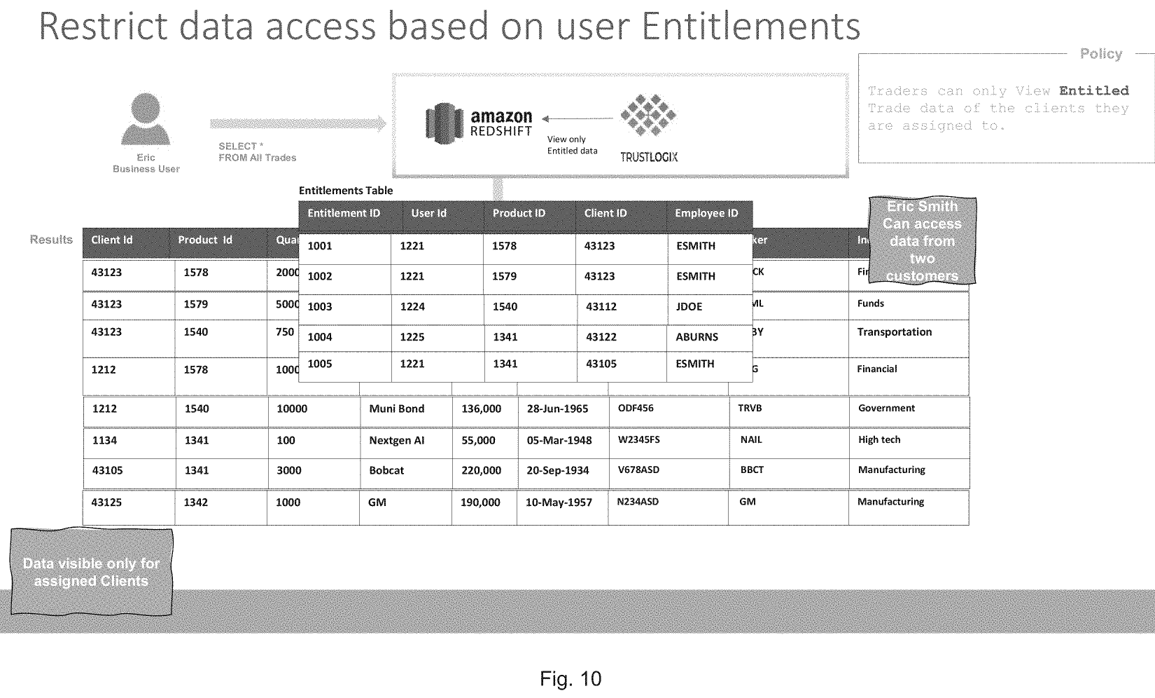

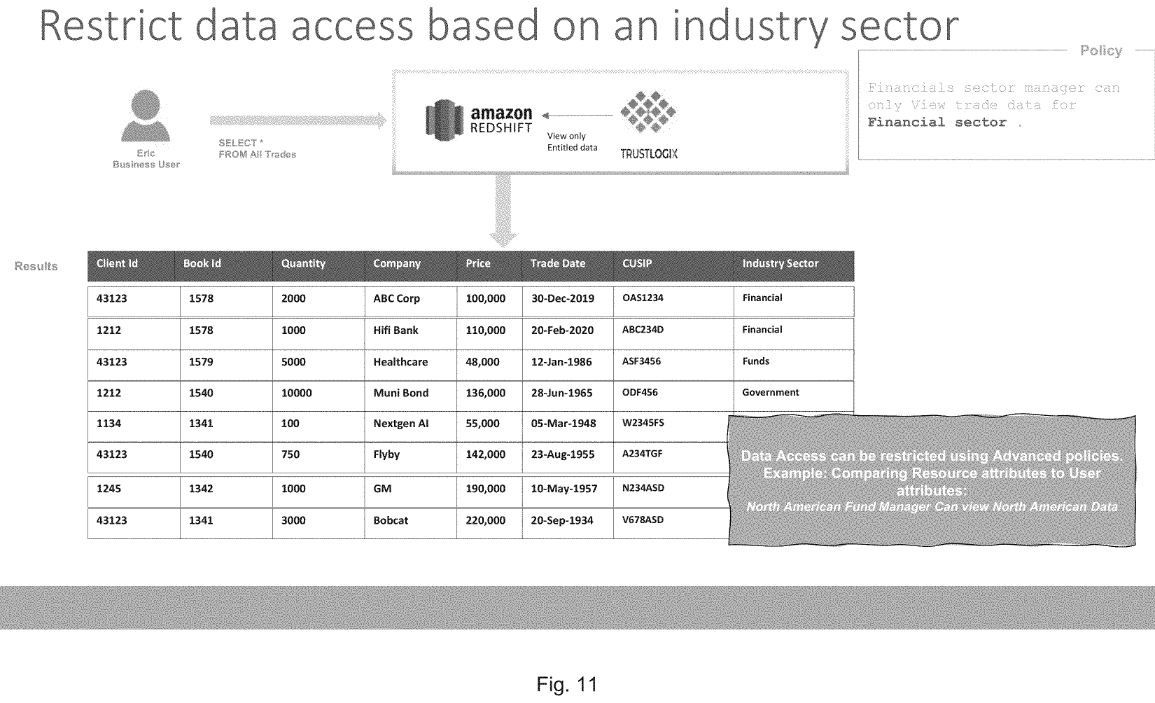

In certain embodiments of the invention, data access controls can be enforced by user entitlements. Entitlements can be in the form of rules that are specified in a lookup table called an entitlements table. An example in accordance with an embodiment of the invention is illustrated in FIG. 10. Entitlement identifiers 1001, 1002, and 1005 permit employee identifier ESMITH to only access two clients 43123 and 43105 with product identifier 1578, 1579, and 1341 and no other data. In some embodiments of the invention, an access policy may filter data that is accessible to a user by comparing one or more resource attributes in the data with user attributes. As an example, referring to FIG. 11 an access control policy is illustrated where the user may view data for the financial sector (i.e., the data has a resource attribute value of “financial”). The policy may be further modified by other attributes, such as geographic region.

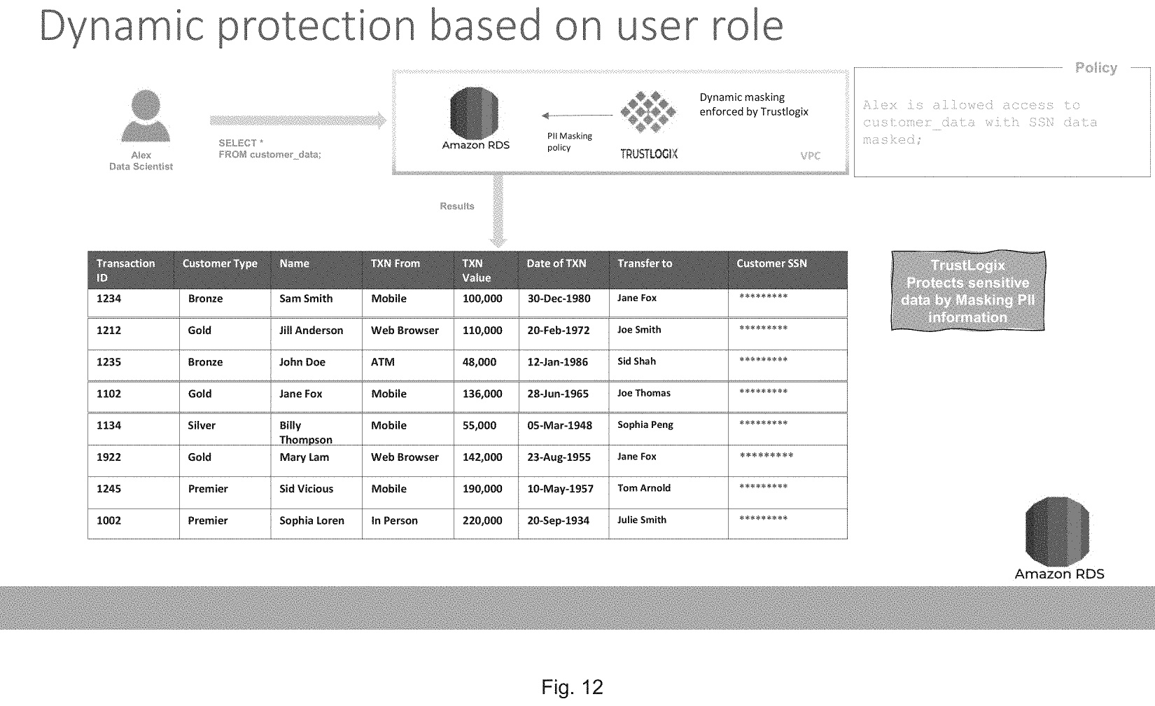

Some access control policies may allow access to data but obscure some part of the data that may be sensitive. An example in accordance with an embodiment of the invention is illustrated in FIG. 12. The customer data is accessible except some fields, such as customer social security number, may be masked so that the value is not visible. While some examples of access control policies are described above, one skilled in the art will recognize that any of a variety of policies may be instituted in a personal data protection system in accordance with embodiments of the invention.

### Privacy Policies

As discussed further above, a privacy policy can include obfuscating personal data in some way, such as encryption (e.g., multi-party compute) and/or depersonalization (e.g., masking, pseudo-anonymization, tokenization, differential privacy, MPC, etc.) in accordance with embodiments of the invention. Certain types of information that may have privacy policies applied can include, but are not limited to, social security numbers, credit card numbers, addresses, birth dates, and/or other types of sensitive personal information. The information can be obfuscated by encrypting it, so that only certain user accounts may access it. In many embodiments of the invention, the personal data protection system does not keep encryption keys to the data, but leaves them in the domain of the customer cloud system.

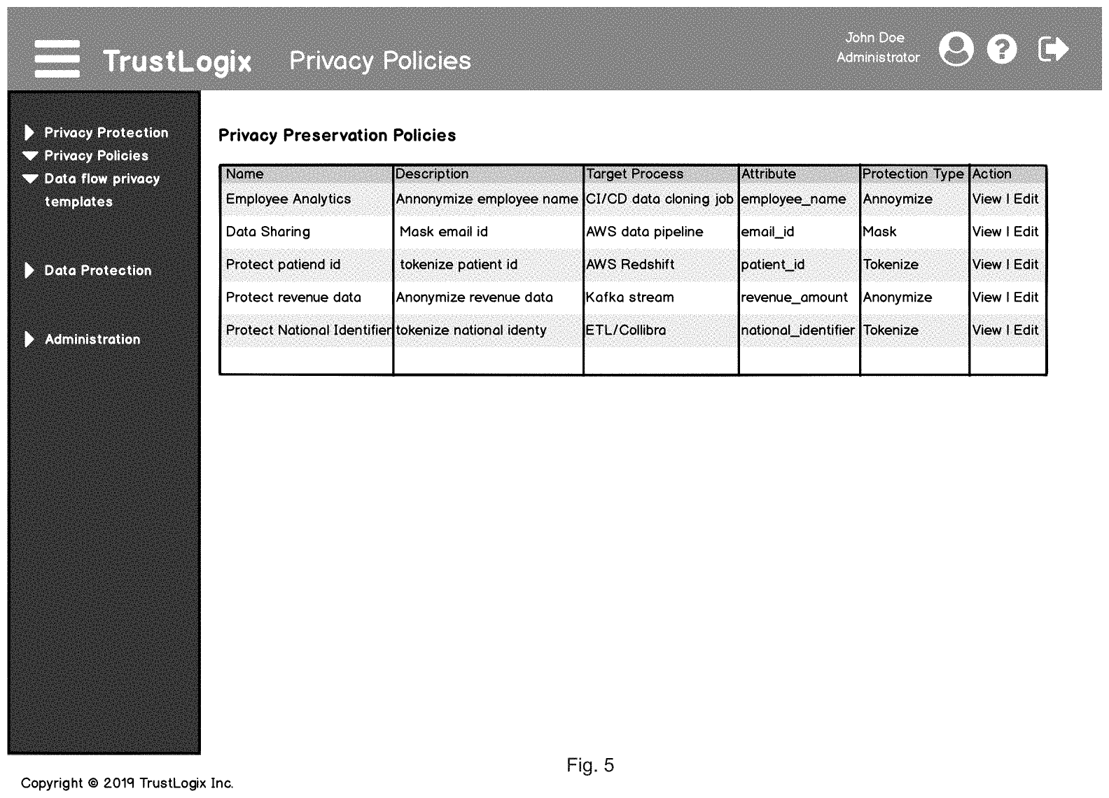

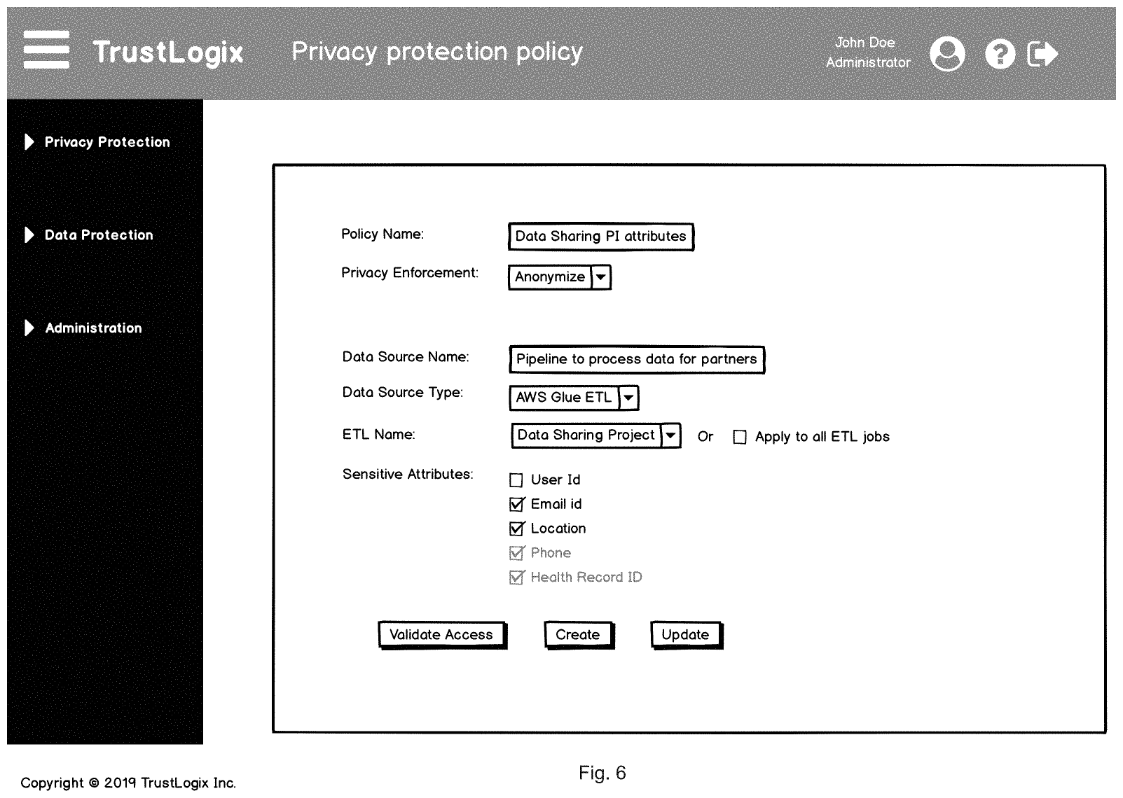

In some embodiments, the sensitive information can also be masked, so that the visibility is limited for certain user accounts. For example, it can be obfuscated to a generic non-unique format so the information is not de-identifiable (the association with a particular person recovered). In some embodiments, sensitive information can be tokenized, so that the data is encrypted but can be de-identified. An example list of categories of protected information and protection type in accordance with an embodiment of the invention is shown in FIG. 5 and a configuration screen shown in FIG. 6. As can be seen in the illustrated examples, some types of information such as employee name and revenue data may be anonymized. Some types of information such as email identifier (ID) may be masked. Additional types of information such as patient ID and national ID may be tokenized. One skilled in the art will recognize that various embodiments of the invention may utilize any of a variety of types of information may be protected by a variety of methods not limited to the techniques described.

### Implementation Form Factors

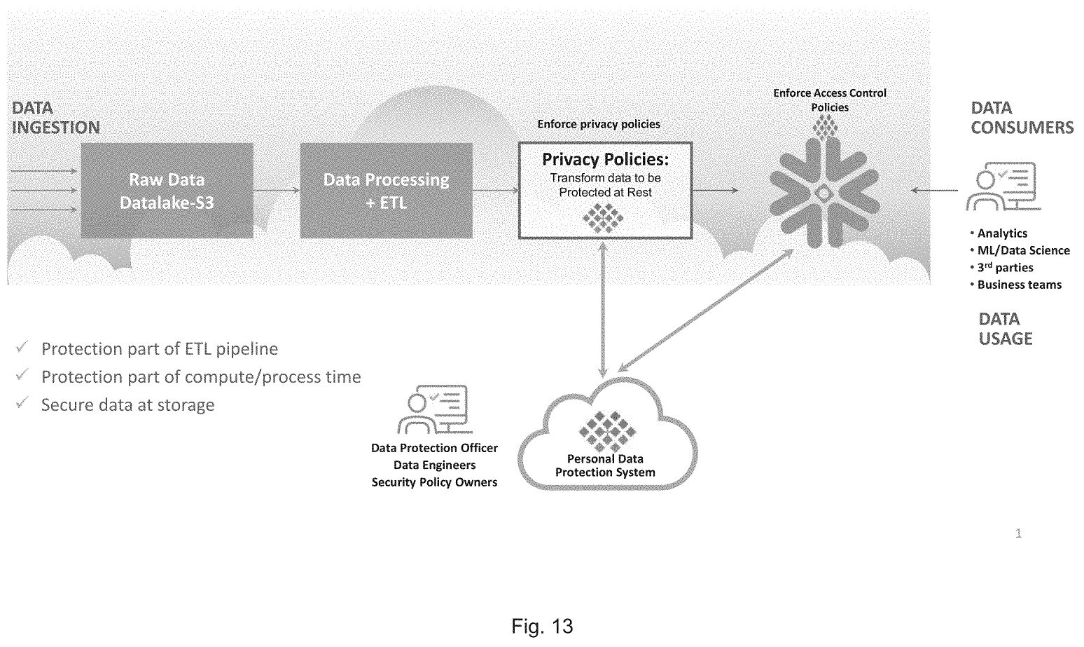

The processes for personal data protection discussed above with respect to certain embodiments of the invention can be generalized as shown in FIG. 13. As mentioned above, personal data protection systems and associated processes in accordance with embodiments of the invention may be implemented as software-as-a-service (SaaS) system. Access control policies and privacy policies may be combined into a package referred to as a trustlet. In some embodiments, the trustlet is within a customer organization's cloud system. It may use highly secure private links referred to as transit gateways to connect to one or more data repositories in the customer organizations cloud system. It may also communicate with a front-end interface system at a SaaS control plane.

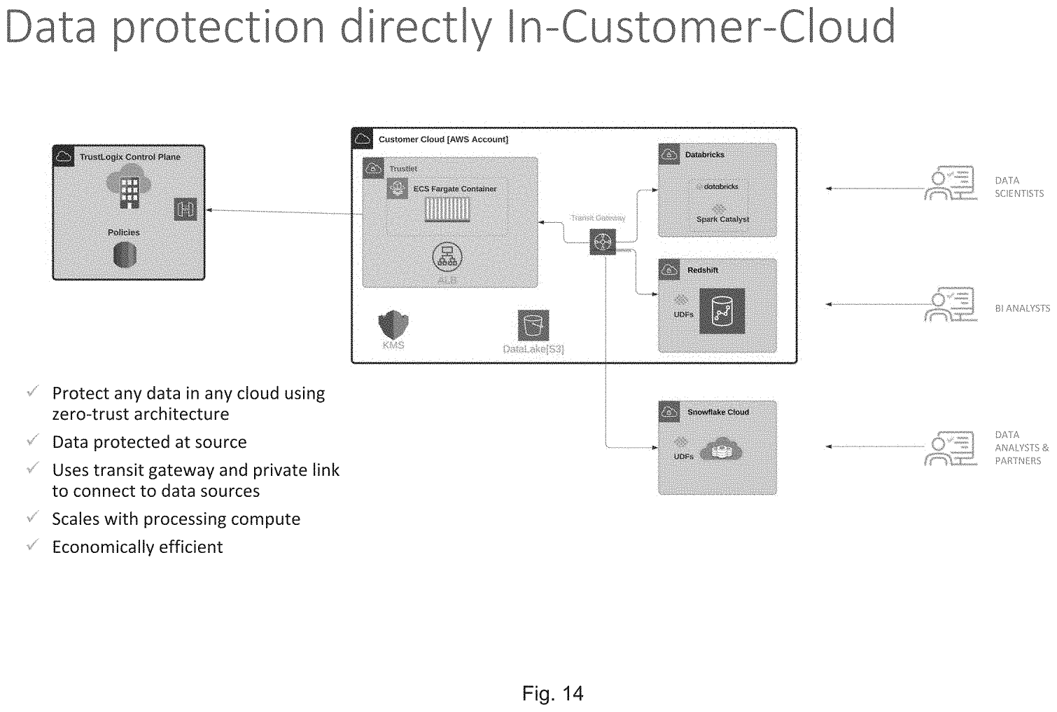

A personal data protection system configured with a trustlet in this manner according to some embodiments of the invention is illustrated in FIG. 14. As can be seen in the figure, privacy and/or access control policies can be created and/or configured using an interface at a control plane. The control plane may communicate with or control a trustlet within a customer cloud. The trustlet may retrieve data from and/or enforce policies on cloud data repositories such as instances of Databricks, Redshift, and/or Snowflake that are within or external to the customer cloud. In other embodiments of the invention, the trustlet may reside in the SaaS control plane and connect to the customer organization's data repositories remotely. One skilled in the art will recognize that other configurations may be implemented in accordance with embodiments of the invention as appropriate to a particular application.

Although the description above contains many specificities, these should not be construed as limiting the scope of the invention but as merely providing illustrations of some of the presently preferred embodiments of the invention. Various other embodiments are possible within its scope. Accordingly, the scope of the invention should be determined not by the embodiments illustrated, but by the appended claims and their equivalents.

What is claimed is:

1. A method for restricting access and visibility to sensitive personal data stored within a data repository, the method comprising:
establishing a connection from a personal data protection system to a data source;
retrieving raw data comprising personal data from the data source using the personal data protection system;
classifying pieces of information within the personal data into one or more levels of sensitivity using the personal data protection system;
storing the raw data in a data repository using the personal data protection system;
enforcing one or more privacy policies on the personal data by obfuscating pieces of information that are at one of the levels of sensitivity using the personal data protection system; and
enforcing one or more access control policies for one or more user accounts having access to the data repository by limiting visibility of the personal data to a subset of the personal data, based upon attributes of the user account, using the personal data protection system.

2. The method of claim 1, wherein retrieving raw data comprises performing extract, transform, and load database operations to obtain raw data.

3. The method of claim 1, further comprising transforming the raw data into a common format for aggregation and storage in the data repository.

4. The method of claim 1, wherein classifying pieces of information within the personal data comprises identifying types of personal data that are named in at least one government consumer privacy regulation.

5. The method of claim 1, wherein obfuscating pieces of information comprises encrypting the pieces of information and not retaining encryption keys within the personal data protection system.

6. The method of claim 1, wherein enforcing one or more access control policies comprises maintaining an entitlement list that specifies what data a user account may access based upon one or more attributes of the data matching predetermined attributes associated with the user account.

7. The method of claim 1, wherein enforcing one or more access control policies comprises obscuring visibility of certain attributes of personal data by a user account.

8. The method of claim 1, wherein the personal data protection system resides within an instance of a cloud service where the personal data is stored and utilizes VPC to VPC (virtual private cloud) peering and private secure links to enforce the one or more access control policies.
